(19) United States
(12) Patent Application Publication
(10) Pub. No.: US 2026/0346263 A1
(43) Pub. Date: Nov. 5, 2026

(54) GRANULATOR MILL

(71) Applicant: RAPID GRANULATOR AB, Bredaryd (SE)

(72) Inventors: Magnus BLOM, Värnamo (SE); Henrik KARLSSON, Värnamo (SE)

(73) Assignee: RAPID GRANULATOR AB, Bredaryd (SE)

(21) Appl. No.: 19/100,028

(22) PCT Filed: Jun. 30, 2023
(86) PCT No.: PCT/EP2023/068076

§ 371 Date: Jan. 30, 2025

(30) Foreign Application Priority Data
Aug. 5, 2022 (EP) 22188962.9

(51) Int. Cl. B02C 18/18

(52) U.S. Cl. CPC B02C 18/18

(57) ABSTRACT

Granulator mill having a cutter housing, a granule chamber with a seat, a rotatable rotor arranged inside the granule chamber which rotor includes a first blade at its periphery. The cutter housing having a fixed second blade arranged on the seat and arranged for cooperation with the first blade of the rotor. The granulator mill further having a stop arranged at the back side of each second blade, which stop is arranged to prevent the second blade from moving away from the rotor. The back side of each second blade further includes a recess and a rotatable tensioning screw is arranged into the recess and into the seat, wherein the upon rotating the tensioning screw, the second blade may be tensioned or loosened in the second direction.

### TECHNICAL FIELD

The present invention relates generally to a granulator mill with easy positioning and adjusting of fixed blades arranged on a seat of the granulator mill.

### BACKGROUND ART

Granulators are used for example within the plastics industry for recycling or reuse of plastic waste. A granulator comprises a granulator mill for grinding plastic waste into granules of approximately the same mutual size. One type of granulator may comprise a so-called cutter housing into which the granulator mill is positioned. The granulator mill may comprise a rotor, onto which periphery knives are arranged and the knives cooperate with the static parts of the cutter housing such as cutter house walls or fixed blades/knives arranged at a frame or a seat or the like, of the cutter housing. The periphery knives of the rotor may be arranged as low knives only protruding a small distance from the rotor.

A known solution is presented in EP3689571A1, which discloses a strand pelletizer for pelletizing a strand of material and which has at least one cutting edge (rotor blade/knife) and an opposite cutting edge (fixed blade/knife). The opposite cutting edge is arranged on a main part which can be moved relative to a support part (seat). The main part can be independently linearly moved relative to the support part and can pivot about at least one pivot axis. The strand pelletizer allows a simple and precise adjustment of the opposite cutting edge but at least has a drawback concerning that the adjustment takes place from the back side of the pelletizer and not from cutter housing side. When a fixed blade of the opposite cutting edge is to be replaced and/or adjusted to a precise position relative the cutting edge (rotor blade), the blade first must be positioned from the front side (cutter housing/rotor side) and then adjusted from the back side (outside the cutter housing), which is tricky and time-consuming.

Another document WO2017173986A1 discloses a wastepaper shredding component and device. The wastepaper shredding component comprises a knife roller capable of rotating about its axis, a flying knife mounted on the knife roller and comprising a first blade means, a knife holder and a bottom knife, mounted on the knife holder. The bottom knife comprises a second blade means engaging with the first blade means to cut wastepaper. The second blade means extends in a direction along the axis of the knife roller. The first blade means is inclined with respect to the second blade means, such that when the knife roller rotates, the first blade means can progressively engage with the second blade means from a first end thereof. This solution shows known adjustment possibilities of both the flying knife (rotor blade) as well as the bottom knife (fixed blade) where the latter is hard to access from the rotor side, and further does not enable a quick and easy way of replacing and/or fine-tuning the position of the bottom knife.

### SUMMARY OF INVENTION

An object of the present invention is to solve the above-mentioned problems and by that provide a granulator mill which have a design which enables easy access and quick adjustment of a fixed blade, and this may be preformed from the cutter housing side. The object is met by the granulator mill according to claim 1.

According to an aspect of the invention, a granulator mill with improved accessibility for adjusting and/or replacing fixed blades of the granulator mill is disclosed. The granulator mill comprises a cutter housing with a granule chamber which extends in a first direction, and the cutter housing comprises a seat. The granulator mill further comprises a rotatable rotor, arranged inside the granule chamber and arranged to rotate around a rotor axis that extends in the first direction. The rotor comprises at least one first blade arranged at a periphery of the rotor, wherein the cutter housing at least partly surrounds the granule chamber. The cutter housing comprises at least one fixed second blade arranged on the seat of the cutter housing, wherein the at least one second blade is arranged for cooperation with the at least one first blade of the rotor, for granulating waste material to granules. The at least one second blade extends in the first direction and also in a second direction, which is transverse the first direction and thus extends in direction towards the rotor. Each second blade comprises a front side which faces the rotor and an opposite back which faces away from the rotor in the mounted state on the seat. The granulator mill further comprises at least one stop per second blade (which stop preferably is adjustable), which stop is arranged at the back side of each second blade, and which stop is arranged to position the second blade in the second direction by preventing the second blade from moving away from the rotor. The back side of each second blade further comprises at least one recess and the granulator mill further comprises at least one rotatable tensioning screw, with a first end and an opposite second end, wherein the first end is arranged into the seat (preferably by a threaded connection with a through hole of the seat, preferably at a back wall of the seat), and the second end of the tensioning screw is arranged into the recess of the second blade. The tensioning screw comprises at least one threaded part for threaded connection to either the seat (for example to a back wall of the seat) or the recess of the second blade and further at least one first grip part arranged to grip with the one of the seat or the recess of the second blade which is not threadedly engaged with the tensioning screw, by the threaded part. Upon rotating the tensioning screw, the second blade may be tensioned or loosened in the second direction.

By such an arrangement, the one or more fixed second blades arranged on the seat of the cutter housing of the granulator mill, is/are easily accessed from the granule chamber/the rotor side, for adjusting or replacing the fixed second blade/blades. Further, since the fixed second blade comprises at least one stop at the back side of each second blade, and which stop is arranged to position the second blade in the second direction by preventing the second blade from moving away from the rotor, a quick pre-setting function of the position of the second blade is achieved. And by that the second blade further comprises the tensioning screw which is connected to the seat and to the second blade via the recess, a further fine-tuning of the position of the second blade in the second direction (towards or away from the rotor/the first blade of the rotor) is possible with access from the granule chamber/the rotor side (front side). Further, the tensioning screw prevents the fixed second blade from moving towards the rotor, wherein the fixed blade, when perfectly positioned relative the first blade of the rotor, is prevented from moving in the second direction (towards or away relative the rotor) by the stop and by tensioning the tensioning screw. The stop and the tensioning screw are separate parts which is positive for the quick pre-setting function of the position of the second blade and the fine-tuning of the position of the second blade in the second direction with access from the granule chamber/the rotor side. Prior Art solution do not provide solutions with easy access from the granule chamber/the rotor side, but instead only from behind, wherein the fine-tuning or presetting must be performed from the back side, even if the fixed blades are fitted into the cutter housing from the front side, which is the normal solution. The back side is often hard to reach because other parts like the motor may be in the way, wherein it is more difficult and time-consuming to adjust and/or remove blades from known granulator mills.

According to an embodiment, the tensioning screw further comprises a grip arrangement for a screw tensioning tool, which grip arrangement is arranged between the first end and the second end of the tensioning screw, wherein the grip arrangement is arranged between the back side of the at least one second blade and the seat (preferably a back wall of the seat) of the cutter housing. By that, the grip is accessible from the cutter housing, wherein the fine-tuning of the blade may be utilized in an easy manner by a tool directly from the cutter housing side. The distance of the stop protruding out from the back wall of the seat is preferably preset from factory and when the second blade is arranged on the seat, either for the first time or if it is replaced by a new blade, the stop abuts the back wall of the seat or another stop part and by that, the second blade may be in perfect position relative the first blade (of the rotor). If that is the case, the tensioning screw is used only to tighten the second blade in direction towards the seat such that the stop prevents a motion of the fixed second blade away from the rotor (i.e. towards the back wall of the seat) and the tensioning screw prevents a motion of the fixed second blade towards the rotor (i.e. away from the back wall of the seat). This, since the tensioning screw is connected to the second blade (via the recess) and to the back wall of the seat, wherein the tensioning “locks” the second blade in the correct position. If the preset distance does not totally correspond to a perfect position of the fixed second blade relative the first blade arranged on the rotor, the stop and the tensioning screw may be adjusted until a perfect position is reached, and then the position of the second blade is secured by the stop and the tensioning screw in the same way as described above. By natural reasons, the first and second blades are worn during longtime use, and the distance between them, which sets the granule size and the performance of the granulating function, might need to be calibrated, and this may be done in an easy way by the easy access of the fixed second blades and the adjustment by the stop and tensioning screw. This is not at hand in prior art solutions.

According to an embodiment, the recess of the second blade is T-shaped as a cut-out with a first part, with a first extension in the second direction and which is open towards the back side of the second blade, and a second part, distal from the back side of the second blade and with a second extension in the first direction. Such a solution enables a corresponding shape of the tensioning screw, wherein a very quick fitting of the second blade on the seat is possible. Preferably, the stops (normally two stops/second blade) are preset and already attached to the back wall of the seat and the tensioning screw is normally attached to the back side of the second blade, wherein it is easy to fit the second blade on the seat by threading the T-shaped recesses over the tensioning screws, wherein the stop is very close to (or abuts) the back wall of the seat (or another stop part, see below), and lower the second blade such that it abuts the seat. If necessary, the second blade is adjusted on the seat to a perfect position relative the first blade of the rotor, and then is locked in this position at least by tensioning the tensioning screw. This provides a quicker setting and locking of the second blade compared to prior art solutions.

According to an embodiment, the tensioning screw comprises a neck portion arranged between the second end and the grip arrangement, which neck portion is dimensionally coordinated with the first part of the recess such that the neck portion fits into the first part of the recess of the second blade.

According to an embodiment, the second end of the tensioning screw is arranged as a stud (or nut) which fits the second part of the recess of the second blade.

According to an embodiment, the grip arrangement of the tensioning screw is arranged as a nut. This provide an easy setting of the tensioning screw by for example a wrench or the like.

According to an embodiment, the at least one stop comprises a first pre-setting screw and a second pre-setting screw, wherein the first pre-setting screw is attached to the back side of the second blade in an adjustable manner such as a distance in the second direction, from the back side of the second blade to a distal end of the first pre-setting screw, is adjustable. Further, the second pre-setting screw is attached to a back wall of the seat of the cutter housing in an adjustable manner such as a distance in the second direction, from the back wall of the seat to a distal end of the second pre-setting screw is adjustable, wherein the position of the second pre-setting screw of the seat aligns with the position of the first pre-setting screw of the second blade. Preferably, the first pre-setting screw is in threaded connection with a threaded hole arranged at the back side of the second blade and the second pre-setting screw preferably is in threaded connection with a threaded through hole arranged at the back wall of the seat. The through hole arranged at the back wall of the seat may of course be a hole without threads and in that case, the second pre-setting screw may be adjusted and locked in position relative the seat by means of a respective nut arranged on both sides of the back wall of the seat and in threaded connection with threads of the second pre-setting screw. The first pre-setting screw and the second pre-setting screw aligns with each other and when mounting the second blade to the seat, the first pre-setting screw abuts the second pre-setting screw which already is mounted at the seat (preferably at the back wall of the seat by threaded connection and a stop nut).

According to an embodiment, the granulator mill further comprises at least two fastening means per second blade, and each second blade has at least two through holes, wherein the at least one second blade is fixed on the seat both on its plane of extension and in a direction transversal to its plane of extension by the at least two fastening means, which extends through the respective through holes of the second blade and the through corresponding holes of the seat. This provides an extra safe and totally fixed second blade, after that the second blade has been perfectly positioned on the seat and relative the first blade of the rotor.

Further possible features and benefits of this solution will become apparent from the detailed description below. Generally, all terms used in the claims are to be interpreted according to their ordinary meaning in the technical field, unless explicitly defined otherwise herein. Further features of, and advantages of, the present invention will become apparent when studying the appended claims and the following description. The skilled person realizes that different features of the present invention may be combined to create embodiments other than those described in the following, without departing from the scope of the present invention.

### BRIEF DESCRIPTION OF DRAWINGS

The invention is now described, by way of example, with reference to the accompanying drawings, in which certain aspects and exemplary embodiments of the invention are shown. The invention may, however, be embodied in many different forms and should not be construed as limited to the embodiments and aspects set forth herein; rather, the embodiments are provided by way of example so that this disclosure will be thorough and complete, and will fully convey the scope of the invention to those skilled in the art. Accordingly, it is to be understood that the present invention is not limited to the embodiments described herein and illustrated in the drawings; rather, the skilled person will recognize that many changes and modifications may be made within the scope of the appended claims. Like reference numerals refer to like elements throughout the description.

FIG. 1a is a perspective view of a granulator mill according to the invention when arranged on a rack and with an outer protective housing which covers an interior of the granulator mill. FIG. 1b is a perspective view of the granulator mill of FIG. 1a when the outer protective housing is removed.

FIG. 2a is a side view of the granulator mill arranged on the rack and without the outer protective housing. FIG. 2b is a cross-section through the granulator mill of FIG. 2a but without the rack.

FIG. 3a is a perspective view of a cutter housing of the granulator mill.

FIG. 3b is a perspective view of the cutter housing of FIG. 3a when cover plates are removed to enable access to fixed second blades of the granulator mill, which are arranged on a seat of the granulator mill, for possibility to adjust or remove/replace the fixed second blade/blades.

FIG. 4a is a perspective cross-section view of a part of the cutter housing of the granulator mill where one cover plate covers one fixed second blade. FIG. 4b is a zoomed view of an area around the fixed second blade of the cutter housing of FIG. 4a when the cover plate is removed for access to the fixed second blade.

FIG. 5a is a perspective view of the seat of the cutter housing of the granulator mill on which two fixed second blades are adjustably arranged. FIG. 5b is a perspective cross-section view of the seat of FIG. 5a, and one of the two adjustably fixed second blades arranged on the seat. FIG. 5c is a cross-section view of the seat of FIG. 5b.

FIG. 6a is a perspective view of a second blade according to the invention with two adjustable stops (pre-setting screws) arranged at a back side of the second blade and the seat (the seat is removed for better visibility) and further two rotatable tensioning screws also arranged at a back side of the second blade and in cooperation with a T-shaped recess of the second blade. Further, three fastening means are arranged through the second blade, transverse the stops and the tensioning screws. FIG. 6b is a top-view of the second blade with a number of recesses, wherein one of the T-shaped recesses is shown in a zoomed view in the figure. FIG. 6c is a top view of the second blade with the adjustable stops and tensioning screws arranged to the second blade. FIG. 6d is a perspective view of one adjustable stop comprising a first pre-setting screw and a second presetting screw and FIG. 6e is a perspective view of one tensioning screw.

### DETAILED DESCRIPTION

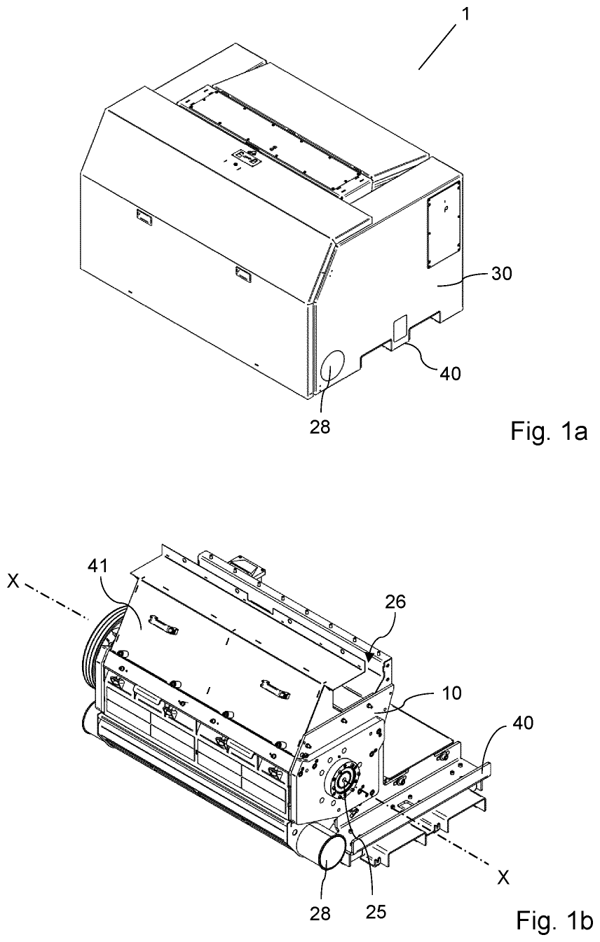

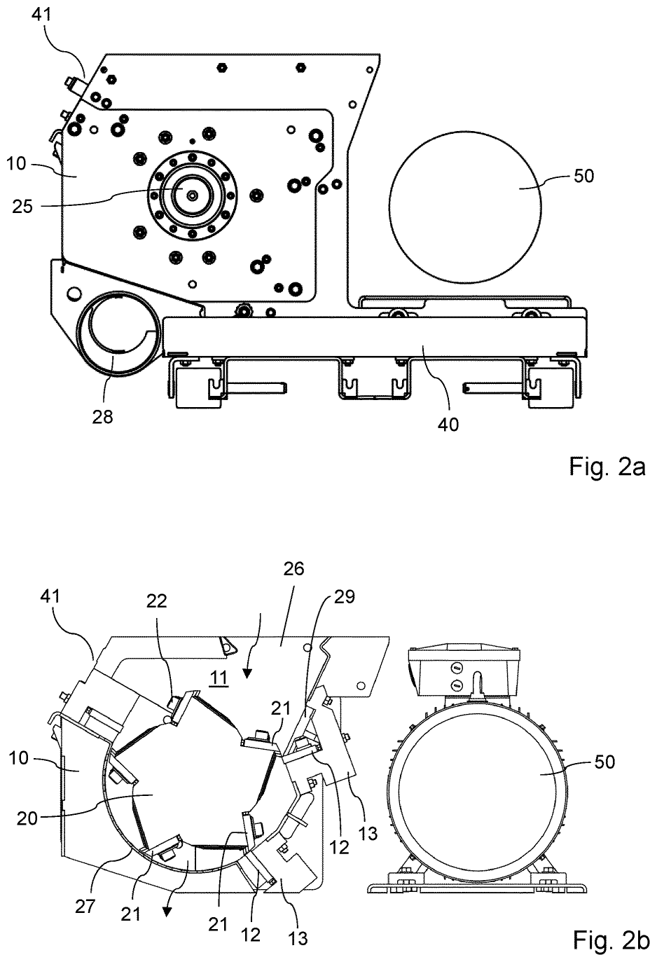

FIG. 1a is a perspective view of a granulator mill 1 according to the invention when arranged on a rack (frame) 40, and with an outer protective housing 30, which covers an interior of the granulator mill 1. FIG. 1b is a perspective view of the granulator mill 1 of FIG. 1a when the outer protective housing 30 is removed. The granulator mill 1 comprises as mentioned the rack 40 onto which a cutter housing 10 is arranged. The rack 40 is arranged to support the cutter housing 10 as well as a motor 50 (not visible, see FIGS. 2a-b) and electrical connections, controls etc. The cutter housing 10 comprises a granule chamber 11 (not visible, see FIG. 2b) which extends in a first direction X, and a rotatable rotor 20 (not visible, see FIG. 2b) is arranged inside the granule chamber 11 and extends in the first direction X, which rotor is arranged to rotate around a rotor axis 25, which extends in the first direction X. To further protect a user from moving parts one or more protective lids 41 are removably arranged at the cutter housing 10. When the granulator mill 1 is to be used for granulating plastic waste to granules, the plastic waste are fed into a feeding section 26 arranged upstream the granule chamber 11. An infeed hopper may be arranged upstream the feeding section 26. The plastic waste material falls from the infeed hopper and/or the feeding section 26 to the granule chamber 11 of the cutter housing 10, normally by gravity, where it is granulated to granules. This will be further explained below. The cutter housing 10 further comprises collection chamber 28, arranged downstream the granule chamber 11, in which the granules are collected and fed out from the granulator mill 1.

FIG. 2a is a side view of the granulator mill 1 arranged on the rack 40 and without the outer protective housing 30 and FIG. 2b is a cross-section through the granulator mill 1 of FIG. 2a but without the rack 40. As can be seen, a granulator mill 1 of this kind is rather compact and is designed to be compact due to different reasons, for example designed to be movable. The granulator mills may be arranged on a rack 40 like the inventive granulator mill 1, to easily be moved by for example a forklift or the like. This means that the motor 50 and the cutter housing 10 are arranged close to each other as can be seen in FIGS. 2a-b. As mentioned in the background, there normally is a problem to adjust and/or replace the fixed blades arranged on the seat.

As mentioned above, the cutter housing 10 comprises the granule chamber 11 wherein the cutter housing 10 at least partly surrounds the granule chamber 11. The granule chamber 11 comprises an open top for receiving the waste material from the feeding section 26. The waste material slides down in the granule chamber 11 towards the rotatable rotor 20, which is arranged inside the granule chamber 11. The rotor 20 is arranged to rotate around the rotor axis 25, and the rotor 20 comprises at least one first blade 21, preferably five “wings” with one or more first blades 21, which are fixedly arranged at a periphery of the rotor 20 (“wings”) by means of screws 22, and each first blade 21 protrudes a bit from the rotor 20, such as a cutting edge is arranged outside the periphery of the rotor 20.

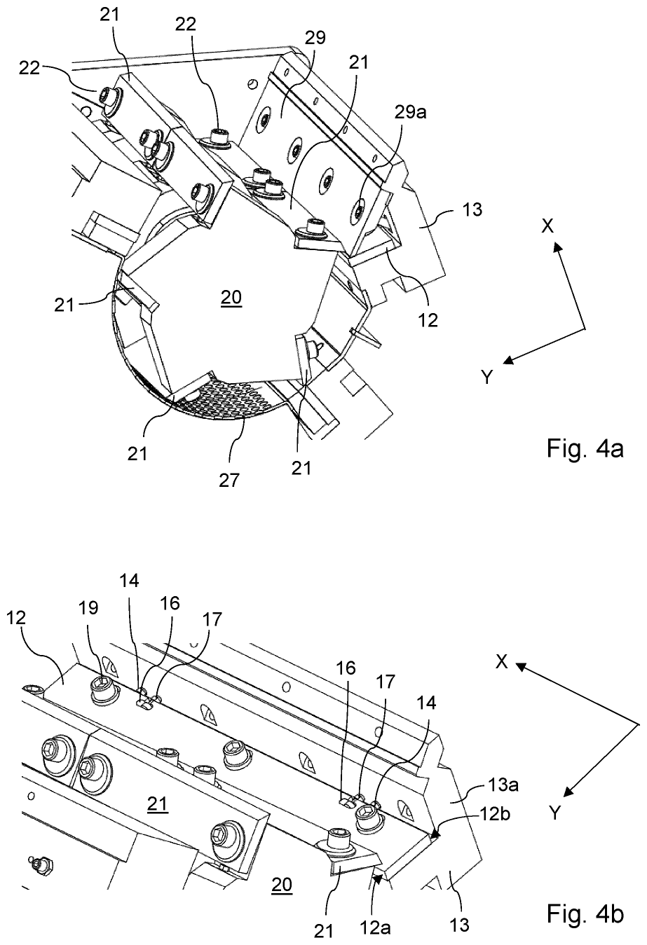

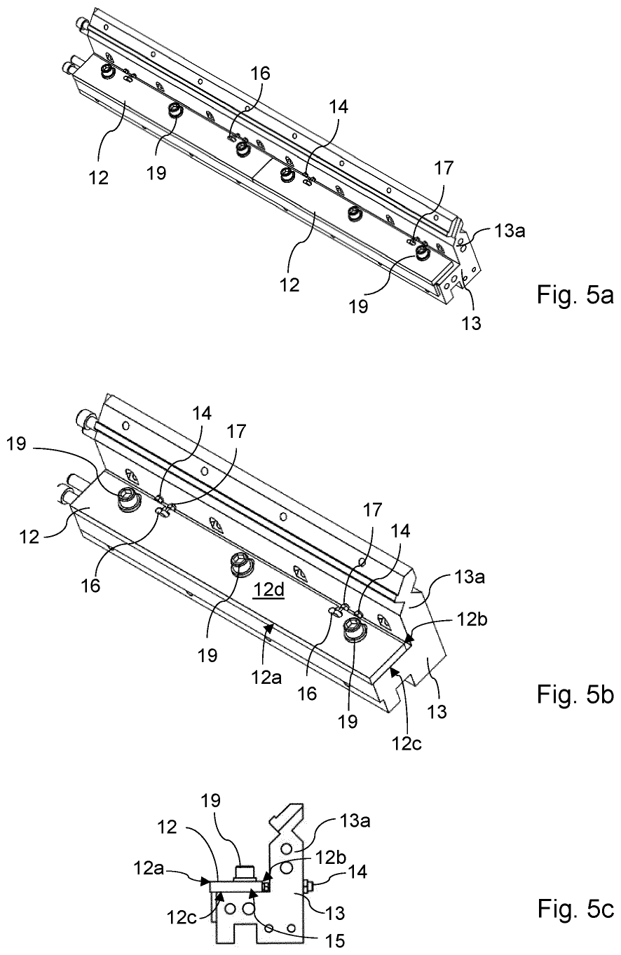

The cutter housing 10 further comprises at least one, preferably two or three, fixed (static) second blade/blades 12, which each are detachably arranged on a respective seat 13 of the cutter housing 10. The second blade 12 is arranged for cooperation with the first blade 21 of the rotor 20, for granulating material to granules. The second blade 12 extends in the first direction X and in a second direction Y, transverse the first direction X, that is towards the rotor 20. When the waste material is fed into the granule chamber 11 (indicated with an upper arrow in FIG. 2b) it falls towards the rotor where the first and second blades 21, 12 granulates the material to granules. The granules falls further down by gravity and passes a grid 27 before they enter the collection chamber 28 for further transport away from the granulator mill 1. The granule chamber 11 is partly covered with the protective lid 41 which is removably arranged at the cutter housing 10 in front of the feeding section 26. The second blade/blades 12 are as mentioned detachably arranged on the seat 13 and is also adjustable on the seat 13. The access to the “adjustment area/replacement area” is protected by a cover plate 29, which is removably arranged to the seat 13 by a number of screws extending through the cover plate 29 and further into threaded connection with the seat 13. The cover plate 29 covers the second blade 12 from a short distance behind a front side 12a (see further FIGS. 4b-5c) of the second blade 12 and backwards and extends in an angle relative a back wall 13a of the seat, such that only a small “cutting edge” of the second blade 12 is exposed to the granule chamber 11.

As mentioned in the background, prior art solutions have a problem to adjust and/or replace the fixed blades in an easy and not too time-consuming way, due to that known solutions do not provide access to finetuning from the granule chamber 11, but instead from the back side (behind the seat). It is easy to understand the problem when considering the very tight design of this type of granulator mill 1, which is a demand for this type. The distance between the backside of the seat 13 and the motor 50, or the distance from the backside of the seat to the rack 40, is very limited and the backside of the seat 13 is normally hard to reach.

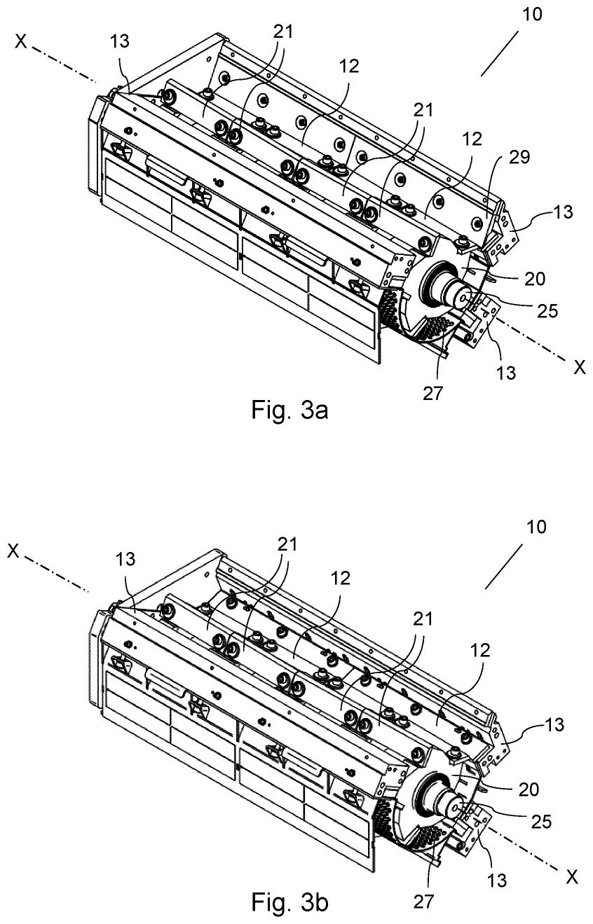

FIG. 3a is a perspective view of a cutter housing 10 of the granulator mill 1. FIG. 3b is a perspective view of the cutter housing 10 of FIG. 3a when two cover plates 29 are removed to enable access to the two second static/fixed blades 12 of the granulator mill 1, arranged on the seat 13 of the granulator mill 1, for possibility to adjust or remove/replace the fixed second blades 12. As can be seen, the cutter housing comprises three seats 13, which each comprises two second blades 12 extending in the first direction X and which are arranged in line with each other, and each second blade 12 is “covered” with one cover plate 29. Further, the rotor 20 comprises five sets of four first blades 21 arranged on a respective “wing” of the rotor 20 and extending in the first direction X, for cooperation with the second fixed blades 12, upon rotation of the rotor 20 around the axis 25. The grid 27 is visible downstream (below) the granule chamber 11 of the cutter housing 10.

FIG. 4a is a perspective cross-section view of an upper part of the cutter housing 10 of the granulator mill 1, where one cover plate 29 covers one fixed second blade 12. FIG. 4b is a zoomed view of an area around the fixed second blade 12 of the cutter housing 10 of FIG. 4a when the cover plate 29 is removed for access to the fixed second blade 12. The inventive solution provides easy access to the second blade 12 from “the front side”, which is from the rotor side. As mentioned above, and as can be seen for example in FIGS. 2a and 2b, it may be hard to reach the backside of the seat 13 to be able to loosen and adjust the fixed blade (the second blade in this case) for this type of granulator mill. The inventive solution solves this problem by the easy access of the second blade 12, wherein the protective cover plate 29 first is removed by unscrewing a number of bolts 29a and then removing the cover plate 29. This reveals the entire second blade 12 and the adjustment possibilities.

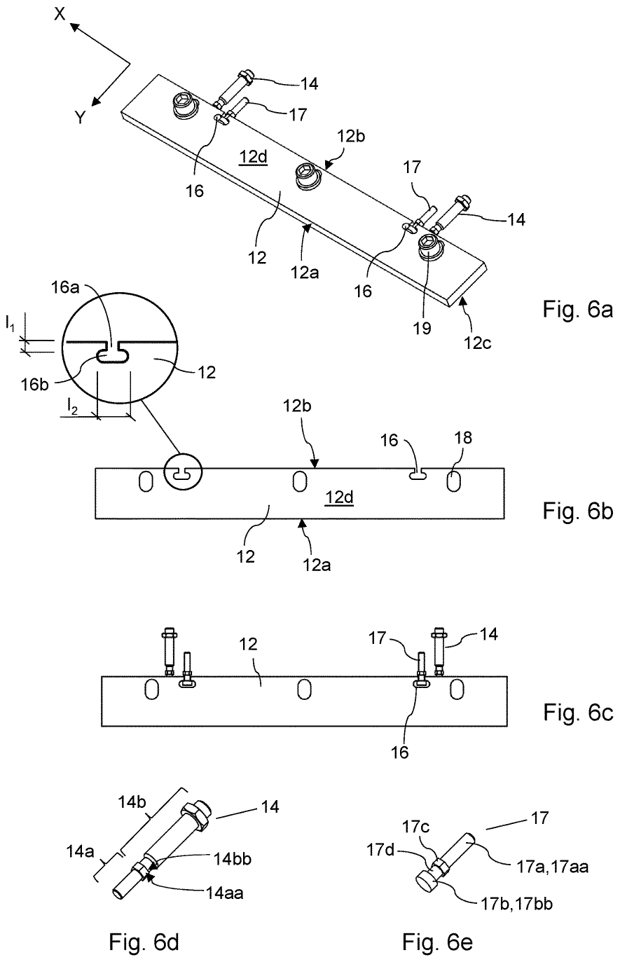

The second blades 12 are as mentioned arranged for cooperation with the first blades 21 of the rotor 20, for granulating waste material to granules, and the second blade 12 extends as mentioned in the first direction X and in a second direction Y, transverse the first direction X, that is towards the rotor 20. The second blade thus comprises a front side 12a, which faces the rotor 20 and an opposite back side 12b, which faces away from the rotor 20. The second blade 12 further comprises at least one, but preferably two adjustable stops 14 arranged at the back side 12b of each second blade 12 (see also FIGS. 6a-e), which stops 14 thus have an extension in the second direction Y. The stops 14 are as mentioned adjustable but should normally not be adjusted since they are preset (factory setting) and sealed when delivered, such that the position of the second blade 12 relative a back wall 13a of the seat 13 is predetermined, wherein the second blade 12 is positioned in the second direction Y and is prevented from moving in direction away from the rotor 20. When the second blade 12 is to be installed for the first time, or is to be replaced by a new one, it is easy and quick to position the second blade 12 on the seat, since the two stops 14 sets the correct distance. For further description of the stop 14, see description below relating to FIG. 6d.

Further, the back side 12b of each second blade 12 comprises at least one, but more preferred, two recesses 16 and the granulator mill 1 further comprises one corresponding rotatable tensioning screw 17 per recess. The tensioning screw has a first end 17a and an opposite second end 17b, wherein the first end 17a is arranged for threaded connection with a corresponding threaded hole into the back wall 13a of the seat 13. The second end 17b of the tensioning screw 17 is arranged to fit into the recess 16 of the second blade 12. When the second blade 12 is positioned in the second direction Y relative the back wall 13a of the seat 13, by the stops 14, and the position is perfect relative the first blade/blades 21 of the rotor 20, for optimal cutting of waste material to granules, the tensioning screws 17 are rotated to cause a tensioning/locking of the second blade 12 in the second direction Y. The rotation of the tensioning screws 17 are in a rotation direction corresponding to a pulling motion of the second blade 12 in direction towards the back wall 13a of the seat 13. By the stops 14, the second blade 12 is prevented from moving any further in direction towards the back wall 13a of the seat 13, and by the tensioning screws 17, the second blade 12 is prevented from moving any further in direction away from the back wall 13a of the seat 13, i.e. in direction towards the rotor 20, and is thereby tightly tensioned in the predetermined position. When this is done, the second blade 12 is further fixed on the seat 13 by at least two, preferably three fastening means 19 per second blade 12. Thus, each second blade 12 has corresponding through holes 18, arranged for the fastening means 19 and the seat 13 has corresponding holes 15, preferably with threads for threaded engagement with the fastening means 19 (i.e. screws 19). Another option is that the holes 15 of the seat 13 are through holes, wherein the fastening means 19 may cooperate with nuts arranged at an underside of the seat 13. Of course, the alternative with through holes 15 may also comprise threads. The number of first blades 21 and second blades 12 is optionable and depends on for example the length of the rotor 20 in the first direction X, and for example may the length of one second fixed blade 12 in the first direction X correspond to the total length of one, two, three etc. first blades 21 of the rotor 20, in the first direction X. In the preferred embodiment, the granulator mill 1 of this size comprises four first blades 21 arranged in line one after another on each “wing” of the star-shaped rotor 20 in the first direction X and are fixed there by screws 22. And the corresponding number of second blades 12 arranged one in line one after another on each of the three different seats 13, are two second blades 12 per seat 13 in the first direction X (see FIGS. 3a-b).

FIG. 5a shows a perspective view of one of the seats 13 of the cutter housing 10 of the granulator mill 1, on which seat 13 the two fixed second blades 12 are adjustably arranged. FIG. 5b shows a perspective cross-section view of the seat of FIG. 5a, and one of the two adjustably fixed second blades 12 arranged on the seat 13. FIG. 5c is a cross-section view of the seat 13 of FIG. 5b. The second blade 12 comprises an underside 12c which faces the seat 13 and an opposite upper side 12d which faces away from the seat 13. The front side 12a of the second blade 12, when the latter is fixedly arranged at the seat 13, is in a position such that an outermost edge protrudes outside a front edge of the seat 13, wherein the front side 12a functions as a cutting blade/knife in cooperation with the rotating first blades 21 of the rotor 20. When the rotor 20 rotates around the axis 25, the first blades 21 passes the second blade/blades 12 and cut the waste material to smaller pieces. Normally, the fixed second blades 12 are not adjusted on site, but instead replaced by other, preset second blades 12, to save down-time of the machine. If the fixed second blade 12 anyway is to be adjusted on site, it is possible, wherein the fastening means 19 are loosened and the seal to the factory set (preset distanced) stops 14 are broken. Now, it is possible to adjust the distance of the stops 14 (their extension from the back side 12b of the second blade 12) to achieve a “perfect” play (normally <0.2 mm) between the blades 12, 21. By rotating the stops 14 and the tensioning screws 17, the second blade 12 may be perfectly adjusted to a correct play, and this from the rotor side of the cutter housing 10/the granule chamber 11, since the stops 14 as well as the tensioning screws 17 are accessible from the cutter housing 10. This is far quicker and easier to do compared to prior art solutions. This will be further explained below. The seat 13 preferably is made of steel or cast iron and comprises holes and a shape arranged for fixed connection to the cutter housing 10. The back wall 13a of the seat 13 comprises through holes arranged for cooperation with the stops 14 of the second blade 12, and a nut is arranged in threaded connection with the stop 14 at the opposite side of the back wall 13a of the seat 13. The stop 14 and the tensioning screw 17 are further described below in relation to FIGS. 6a-6e.

FIG. 6a is a perspective view of one second blade 12 according to the invention with two adjustable stops 14 (pre-setting screws) arranged at the back side 12b of the second blade 12 (and at the seat 13, see below) and further two rotatable tensioning screws 17 also arranged at the back side 12b of the second blade 12 and in cooperation with a T-shaped recess 16 of the second blade 12. The stop 14 and the tensioning screw 17 are separate parts which is positive for the quick pre-setting function of the position of the second blade and the fine-tuning of the position of the second blade in the second direction with access from the granule chamber/the rotor side. Further, the three fastening means 19 are arranged through the second blade 12, transverse the stops 14 and the tensioning screws 17. FIG. 6b is a top view of the second blade 12 with a number of recesses 16, 18, wherein one of the T-shaped recesses 16 is shown in a zoomed view in the figure. FIG. 6c is a top view of the second blade 12 with the adjustable stops 14 and tensioning screws 17 arranged to the second blade 12 (the seat is removed for better visibility). FIG. 6d is a perspective view of one adjustable stop 14 comprising a first pre-setting screw 14a and a second presetting screw 14b and FIG. 6e is a perspective view of one tensioning screw 17.

The second blade 12 which is shown alone in FIG. 6b is arranged as a rectangular steel plate with the front side 12a intended to face the rotor 20 in the assembled state on the seat 13 (rotor and seat not visible), the back side 12b, opposite the front side 12a, the underside 12c which is intended to face the seat 13 and the opposite upper side 12d. Further the three through holes 18, arranged for the fastening means 19, are evenly distributed in the first direction X of the extension of the second blade 12. Further, the two recesses 16 are arranged as T-shaped cut-outs, each with a first part 16a, with a first extension I₁ in the second direction Y and which first part 16a is open towards the back side 12b of the second blade 12, and a second part 16b, which is distal from the back side 12b of the second blade 12 and which has a second extension I₂ in the first direction X and is open towards the first part 16a of the recess 16. This may be seen in the zoomed view of one recess 16 at the left side of the figure. The second blade 12 may also be flipped 180° such that the upper side 12d faces the seat 13 and the underside faces away from the seat 13, if for some reasons one of the edges is more worn than the other.

The stop 14, which is showed in detail in FIG. 6d, preferably is in the form of two threaded pins, where the first presetting screw 14a of the stop 14 is arranged as a threaded pin for threaded connection with a corresponding threaded hole at the back side 12b of the second blade 12. The second presetting screw 14b of the stop 14 is arranged as a threaded pin for threaded connection with a through hole of the back wall 13a of the seat 13 (not visible), and a nut is arranged around a threaded part of the same, which nut is arranged to abut a back side of the back wall 13a of the seat 13. The seat 13 is removed from the FIGS. 6a-6e for better visibility. When about to assemble the second blade 12 on the seat 13, the seat 13 is already prepared with two pre-mounted second presetting screws 14b of the stop 14, which are screwed from the back side of the back wall 13a of the seat 13 and pre-set so to speak, by means of the nut, such that the second presetting screws 14b protrudes a predetermined distance from the back wall 13a of the seat 13, in direction towards the rotor side/the cutter housing 10, to a distal end 14bb of each second presetting screw 14b. Preferably, the second presetting screws 14b are sealed with a breakable seal, which may be broken if the second presetting screws 14b need to be adjusted or a major breakdown occurs. Adjustment of the second presetting screws 14b is normally avoided, since the normal procedure, if the play between the first and second blades 21, 12 is changed due to wear of the blades, is to change the second blade 12 to another, pre-set blade. The second blade 12 is also prepared, but with two first presetting screws 14a of the stop 14, which are screwed into the back side 12b of the second blade 12 into a “sluggish” insert thread (mid-grip screw lock) and pre-set so to speak, such that they protrudes a predetermined distance from the back side 12b of the second blade 12, in direction away from the back side 12b to a distal end 14aa of each first presetting screw 14a. This is performed in a presetting fixture outside the production line/operating facility of the granulator mill, where the second blade 12 is positioned in the fixture between a back wall and a front wall of the presetting fixture. The first presetting screws 14a are adjusted by use of Allen keys such as the protruding distance backwards is such that a feeler gauge, positioned between the front side 12a of the second blade 12 and the front wall of the fixture, starts to get clamped. Preferably, the first presetting screws 14a also are sealed with a breakable seal, which may be broken if the first presetting screws 14b need to be adjusted. Adjustment of the first presetting screws 14a is normally avoided for the same reasons as for the second presetting screws 14b, since the normal procedure, if the play between the first and second blades 21, 12 is changed due to wear of the blades, is to change the second blade 12 to another, pre-set blade. The first presetting screw 14a comprises a grip part in the form of for example a nut-shaped grip part arranged at the outermost end 14aa of the first presetting screw 14a. When assembling the second blade 12 on the seat 13, the first presetting screws 14a of the second blade 12 are aligned with the second presetting screws 14b of the seat 13 such that the outermost ends 14aa of the first presetting screws 14a abuts the outermost ends 14bb of the second presetting screws 14b. In that way, the second blade 12 is positioned in a factory-set position in the second direction Y, wherein the second blade 12 is prevented from moving in direction away from the rotor 20/the first blades 21.

The tensioning screw 17 is showed in detail in FIG. 6e and comprises a first end 17a and an opposite second end 17b. The first end 17a comprises a threaded part 17a, 17aa which preferably is a threaded pin part for threaded connection to a corresponding threaded hole in the back wall 13a of the seat 13 (not visible). The tensioning screw 17 further comprises a first grip part 17bb arranged at the second end 17b, which first grip part 17bb is arranged to grip/engage with the recess 16 of the second blade 12. The first grip part 17bb may be arranged as a stud or a nut. The tensioning screw 17 further comprises a grip arrangement 17c arranged for a screw tensioning tool, which grip arrangement 17c is arranged between the first end 17a and the second end 17b of the tensioning screw 17, and preferably is in the form of a nut-shaped grip part. The tensioning screw 17 may be made as one single part or may comprise several parts, for example a screw with a nut head and a fixed nut, where the latter serves as the grip part, arranged between the first threaded end 17a and the second nut head end 17b. When the second blade 12 is mounted on the seat 13, the grip arrangement 17c is accessible from the cutter housing 10 between the back side 12b of the at least one second blade 12 and the seat 13 of the cutter housing 10.

Returning to the assembly procedure of the second blade 12 on the seat 13 (see also for example FIG. 4b), and as explained above, the first presetting screws 14a of the second blade 12 are aligned with the second presetting screws 14b of the seat 13 such that the outermost ends 14aa of the first presetting screws 14a abuts the outermost ends 14bb of the second presetting screws 14b. Simultaneously, the first grip parts 17bb of each second end 17b of the tensioning screws 17, are introduced into the recess 16 of the second blade 12, such that the first grip parts 17bb fits into the respective second part 16b of each recess 16 and a neck portion 17d of each tensioning screw 17 fits into the first part 16a of the recess 16 of the second blade 12. The neck portion 17d is arranged between the second end 17b/first grip part 17bb and the grip arrangement 17c and is dimensionally coordinated with the first part 16a of the recess 16. This means that the second blade 12 is positioned relative the tensioning screws 17 by the interaction between the recesses 16, which position corresponds to the aligned position of the first and second presetting screws 14a, 14b of the stops 14. Thus, the second blade 12 is positioned “from above” in direction downwards, towards the seat 13. Of course, a small play must be available between edges between the first and second parts 16a, 16b of the recess 16 and edge parts of the first grip part 17bb of the tensioning screw 17, to fit the second blade 12 to the seat 13. To make sure a solid and fixed positioning of the second blade 12 to the seat 13, the tensioning screw 17 is rotated by means of a tool in cooperation with the grip arrangement 17c, such that when rotating the tensioning screw 17, the second blade 12 is “tensioned” in direction towards the back wall 13a of the seat 13, wherein the second blade 12 is totally fixed in the second direction Y, due to the stops 14 and the tensioning screws 17. After this, the fastening means 19 are used to further fix the second blade 12 to the bottom of the seat 13, wherein the second blade 12 is fixed both on its plane of extension and in a direction transversal to its plane of extension. And vice versa, if the second blade 12 needs to be changed or sharpened, the fastening means 19 are unscrewed and the second blade 12 may be loosened by rotating the tensioning screws 17 in the opposite rotation direction. After this, the second blade 12 may be removed.

It is understood by studying the drawings and the description above that such a solution for fixing and adjusting the second blade 12 to the seat 13 provides an easy access from the rotor side/the cutter housing 10 with no need to reach in behind the cutter housing 10, in the narrow space between the cutter housing 10 and the motor 50 and/or the rack 40 etc.

The person skilled in the art realizes that the present invention by no means is limited to the preferred embodiments described above. On the contrary, many modifications and variations are possible within the scope of the appended claims. Additionally, variations to the disclosed embodiments can be understood and effected by the skilled person in practicing the claimed invention, from a study of the drawings, the disclosure, and the appended claims.

Reference to an element in the singular is not intended to mean “one and only one” unless explicitly so stated, but rather “one or more.”

1. A granulator mill, comprising:
a cutter housing with a granule chamber which extends in a first direction, the cutter housing having a seat, the granulator mill further comprising:
a rotatable rotor arranged inside the granule chamber and arranged to rotate around a rotor axis that extends in the first direction, the rotor comprising at least one first blade arranged at a periphery of the rotor,
wherein the cutter housing at least partly surrounds the granule chamber, the cutter housing comprising at least one fixed second blade arranged on the seat of the cutter housing, wherein the at least one second blade is arranged for cooperation with the at least one first blade of the rotor, for granulating material to granules, the at least one second blade extending in the first direction and in a second direction transverse the first direction towards the rotor, wherein each second blade comprises a front side facing the rotor and an opposite back side facing away from the rotor, wherein the granulator mill further comprises at least one stop per second blade arranged at the back side of each second blade, which stop is arranged to position the second blade in the second direction by preventing the second blade from moving away from the rotor,
wherein the back side of each second blade comprises at least one recess and the granulator mill further comprises at least one rotatable tensioning screw, with a first end and an opposite second end, wherein the first end is arranged into the seat, and the second end of the tensioning screw is arranged into the recess of the second blade, wherein the tensioning screw comprises at least one threaded part for threaded connection to either the seat or the recess of the second blade and further at least one first grip part arranged to grip with the one of the seat or the recess of the second blade which is not threadedly engaged with the tensioning screw by the threaded part, wherein upon rotating the tensioning screw the second blade may be tensioned or loosened in the second direction.

2. The granulator mill according to claim 1, wherein the tensioning screw further comprises a grip arrangement for a screw tensioning tool, which grip arrangement is arranged between the first end and the second end of the tensioning screw, wherein the grip arrangement is arranged between the back side of the at least one second blade and the seat of the cutter housing, in the mounted position of the second blade on the seat.

3. The granulator mill according to claim 1, wherein the recess of the second blade is T-shaped as a cut-out with a first part with a first extension in the second direction and which is open towards the back side of the second blade, and a second part distal from the back side of the second blade and with a second extension in the first direction.

4. The granulator mill according to claim 3, wherein the tensioning screw comprises a neck portion arranged between the second end and the grip arrangement, which neck portion is dimensionally coordinated with the first part of the recess such that the neck portion fits into the first part (16a) of the recess of the second blade.

5. The granulator mill according to claim 3, wherein the second end of the tensioning screw is arranged as a stud which fits the second part of the recess of the second blade.

6. The granulator mill according to claim 2, wherein the grip arrangement of the tensioning screw is arranged as a nut.

7. The granulator mill according to claim 1, wherein the at least one stop comprises a first pre-setting screw and a second pre-setting screw, wherein the first pre-setting screw is attached to the back side of the second blade in an adjustable manner such that a distance in the second direction, from the back side of the second blade to a distal end of the first pre-setting screw, is adjustable, and wherein the second pre-setting screw is attached to the back wall of the seat of the cutter housing in an adjustable manner such that a distance in the second direction, from the back wall of the seat to a distal end of the second pre-setting screw is adjustable, wherein the position of the second pre-setting screw of the seat aligns with the position of the first pre-setting screw of the second blade.

8. The granulator mill according to claim 1, further comprising at least two fastening means per second blade, and each second blade having at least two through holes, wherein the at least one second blade is fixed on the seat both on its plane of extension and in a direction transversal to its plane of extension by the at least two fastening means, which extends through the respective through holes of the second blade and through corresponding holes of the seat.

9. The granulator mill according to claim 2, wherein the recess of the second blade is T-shaped as a cut-out with a first part with a first extension in the second direction and which is open towards the back side of the second blade, and a second part distal from the back side of the second blade and with a second extension in the first direction.

10. The granulator mill according to claim 4, wherein the second end of the tensioning screw is arranged as a stud which fits the second part of the recess of the second blade.

11. The granulator mill according to claim 3, wherein the grip arrangement of the tensioning screw is arranged as a nut.

12. The granulator mill according to claim 4, wherein the grip arrangement of the tensioning screw is arranged as a nut.

13. The granulator mill according to claim 5, wherein the grip arrangement of the tensioning screw is arranged as a nut.

14. The granulator mill according to claim 2, wherein the at least one stop comprises a first pre-setting screw and a second pre-setting screw, wherein the first pre-setting screw is attached to the back side of the second blade in an adjustable manner such that a distance in the second direction, from the back side of the second blade to a distal end of the first pre-setting screw, is adjustable, and wherein the second pre-setting screw is attached to the back wall of the seat of the cutter housing in an adjustable manner such that a distance in the second direction, from the back wall of the seat to a distal end of the second pre-setting screw is adjustable, wherein the position of the second pre-setting screw of the seat aligns with the position of the first pre-setting screw of the second blade.

15. The granulator mill according to claim 3, wherein the at least one stop comprises a first pre-setting screw and a second pre-setting screw, wherein the first pre-setting screw is attached to the back side of the second blade in an adjustable manner such that a distance in the second direction, from the back side of the second blade to a distal end of the first pre-setting screw, is adjustable, and wherein the second pre-setting screw is attached to the back wall of the seat of the cutter housing in an adjustable manner such that a distance in the second direction, from the back wall of the seat to a distal end of the second pre-setting screw is adjustable, wherein the position of the second pre-setting screw of the seat aligns with the position of the first pre-setting screw of the second blade.

16. The granulator mill according to claim 4, wherein the at least one stop comprises a first pre-setting screw and a second pre-setting screw, wherein the first pre-setting screw is attached to the back side of the second blade in an adjustable manner such that a distance in the second direction, from the back side of the second blade to a distal end of the first pre-setting screw, is adjustable, and wherein the second pre-setting screw is attached to the back wall of the seat of the cutter housing in an adjustable manner such that a distance in the second direction, from the back wall of the seat to a distal end of the second pre-setting screw is adjustable, wherein the position of the second pre-setting screw of the seat aligns with the position of the first pre-setting screw of the second blade.

17. The granulator mill according to claim 5, wherein the at least one stop comprises a first pre-setting screw and a second pre-setting screw, wherein the first pre-setting screw is attached to the back side of the second blade in an adjustable manner such that a distance in the second direction, from the back side of the second blade to a distal end of the first pre-setting screw, is adjustable, and wherein the second pre-setting screw is attached to the back wall of the seat of the cutter housing in an adjustable manner such that a distance in the second direction, from the back wall of the seat to a distal end of the second pre-setting screw is adjustable, wherein the position of the second pre-setting screw of the seat aligns with the position of the first pre-setting screw of the second blade.

18. The granulator mill according to claim 6, wherein the at least one stop comprises a first pre-setting screw and a second pre-setting screw, wherein the first pre-setting screw is attached to the back side of the second blade in an adjustable manner such that a distance in the second direction, from the back side of the second blade to a distal end of the first pre-setting screw, is adjustable, and wherein the second pre-setting screw is attached to the back wall of the seat of the cutter housing in an adjustable manner such that a distance in the second direction, from the back wall of the seat to a distal end of the second pre-setting screw is adjustable, wherein the position of the second pre-setting screw of the seat aligns with the position of the first pre-setting screw of the second blade.

19. The granulator mill according to claim 2, further comprising at least two fastening means per second blade, and each second blade having at least two through holes, wherein the at least one second blade is fixed on the seat both on its plane of extension and in a direction transversal to its plane of extension by the at least two fastening means, which extends through the respective through holes of the second blade and through corresponding holes of the seat.

20. The granulator mill according to claim 3, further comprising at least two fastening means per second blade, and each second blade having at least two through holes, wherein the at least one second blade is fixed on the seat both on its plane of extension and in a direction transversal to its plane of extension by the at least two fastening means, which extends through the respective through holes of the second blade and through corresponding holes of the seat.
